(19) United States
(12) Patent Application Publication
(10) Pub. No.: US 2004/0208570 A1
(43) Pub. Date: Oct. 21, 2004

(54) Wavelength-oriented virtual networks

(76) Inventor: Scot A. Reader, Sherman Oaks, CA (US)

Correspondence Address: Scot A. Reader, Esq., 3424 Woodcliff Road, Sherman Oaks, CA, 91403, US

(21) Appl. No.: 10/418,336

(22) Filed: Apr. 18, 2003

(51) Int. Cl. H04J 14/02

(52) U.S. Cl. 398/79; 398/58

(57) ABSTRACT

A communication network infrastructure for implementing wavelength-oriented virtual networks. Packets are identified to virtual networks and are forwarded/filtered by reference to the wavelength on which they are transmitted. Such virtual networks may be considered “lambda area networks” in that virtual network classification and forwarding/filtering decisions are made based on whether ports of the network infrastructure support, or do not support, the wavelength, or lambda, on which packets are transmitted by other ports of the network infrastructure.

### BACKGROUND OF THE INVENTION

The present invention relates generally to data communication networking. More particularly, the present invention relates to a method and apparatus for dividing a physical network into a number of distinct virtual networks, whereby communication is allowed only between end-nodes which are members of a common virtual network.

Data communication networks interconnect data communication end-nodes, such as PCs, workstations, servers and printers, for data communication applications, such as email and file transfer. Such interconnectivity is often accomplished using local area network (LAN) protocols, such as Ethernet protocols.

The lack of inherent access restrictions in data communication networks has given rise to significant concerns about privacy and security of transmitted data. Virtual networking has become a primary tool to address these concerns. In virtual networking, a physical network is partitioned into multiple logical networks, called virtual networks. Each virtual network includes a collection of data communication end-nodes that together form a logical work group within a larger network. The flow of traffic across virtual network boundaries is restricted to prevent nonmembers of a virtual network from gaining access to the resources of the virtual network.

Known virtual networks have been implemented as label-oriented constructs. That is, packets are permitted or denied access to virtual networks by reference to an explicit label, such as a MAC address, a virtual local area network identifier (VLAN ID), an IP address or a source port ID, associated with the packets. One shortcoming of implementing virtual networks as label-oriented constructs is the required overhead. Label-oriented virtual networks typically require, at a minimum, a first database lookup of an explicit label to classify packets into virtual networks and a second database lookup to apply the virtual network classifications to render forwarding/filtering decisions. As a result of the overhead attendant in these lookups, label-oriented virtual networks have imposed a significant tax on networks, both in terms of cost and performance.

### SUMMARY OF THE INVENTION

The present invention, in a basic feature, unmoors virtual networks from labels by implementing wavelength-oriented virtual networks. Packets are identified to virtual networks and are forwarded/filtered by reference to the wavelength on which they are transmitted. Such virtual networks may be considered “lambda area networks” (λANs) in that virtual network identification and forwarding/filtering decisions are made based on whether ports of the network infrastructure support, or do not support, the wavelength, or lambda, on which packets are transmitted by other ports of the network infrastructure. Where the network infrastructure consists of a single switching domain, application of virtual network labels may be altogether avoided. Where the network infrastructure consists of multiple switching domains, application of virtual network labels may be limited strictly to inter-domain transmission.

The invention may be advantageously employed in a network infrastructure of the type including a number of optical switching domains, such as optical bridges, interconnected to provide data communication between a number of end-nodes, such as PCs, workstations, servers and printers. The invention provides a method and apparatus for maintaining the integrity of virtual network boundaries within such a network infrastructure using wavelength filtering. The invention operates to prevent communication across virtual network boundaries by inhibiting transmission of packets from output ports of the network infrastructure which do not share a virtual network with the packet's input port to the network infrastructure. Such transmission inhibition is accomplished, in a preferred embodiment, using a combination of port level wavelength filtering of locally originated (e.g. intra-domain) packets and virtual network level wavelength filtering of remotely originated (e.g. inter-domain) packets.

More particularly, in a preferred embodiment, edge ports of the network infrastructure, and by implication the end-nodes which have access the network infrastructure through such edge ports, are assigned to one or more virtual networks. Transmit and receive wavelengths are then judiciously assigned to the edge ports to implement the virtual networks.

To maintain virtual network boundaries when transmitting locally originated packets, edge ports are assigned port level receive wavelengths corresponding to transmit wavelengths assigned to other edge ports within the same domain with which the edge ports share a virtual network. Optical transmitters associated with the edge ports transmit packets inbound from end-nodes on their assigned transmit wavelengths. Optical receivers associated with the other edge ports are applied individually to pass-through ones of the locally originated packets which are received on their assigned port level receive wavelengths, and filter ones of the locally originated packets which received on other wavelengths.

To maintain virtual network boundaries when transmitting remotely originated packets, edge ports are also assigned virtual network level receive wavelengths corresponding to transmit wavelengths assigned to a backbone port within the same domain for virtual networks the edge ports support. The optical transmitter associated with the backbone port transmits packets inbound from remote domains on transmit wavelengths corresponding to the virtual networks into which the packets were classified by the remote domain. Optical receivers associated with the edge ports are then applied individually to pass-through ones of the remotely originated packets which are received on their assigned virtual network level receive wavelengths, and filter ones of the remotely originated packets which are received on other wavelengths.

In the above manner, connectivity is permitted between input/output port pairs in the network infrastructure which belong to a common virtual network, and is inhibited between pairs which do not belong to a common virtual network, using wavelength filtering.

These and other aspects of the invention will be better understood by reference to the detailed description of the preferred embodiment taken in conjunction with the drawings briefly described below. Of course, the invention is defined by the appended claims.

### BRIEF DESCRIPTION OF THE DRAWINGS

FIG. 1 is a block diagram showing a bridged local area network infrastructure in accordance with the present invention;

FIG. 2 is a block diagram showing an optical bridge and a network manager within the bridged local area network infrastructure in accordance with the present invention;

FIG. 3 is a block diagram showing a representative optical transmitter and optical receiver operative within the optical bridge in accordance with the present invention;

FIG. 4 is a block diagram showing a bridge manager operative within the optical bridge in accordance with the present invention; and

FIG. 5 is a flow diagram describing a wavelength-oriented virtual network protocol for the optical bridge in accordance with the present invention.

### DETAILED DESCRIPTION OF THE PREFERRED EMBODIMENT

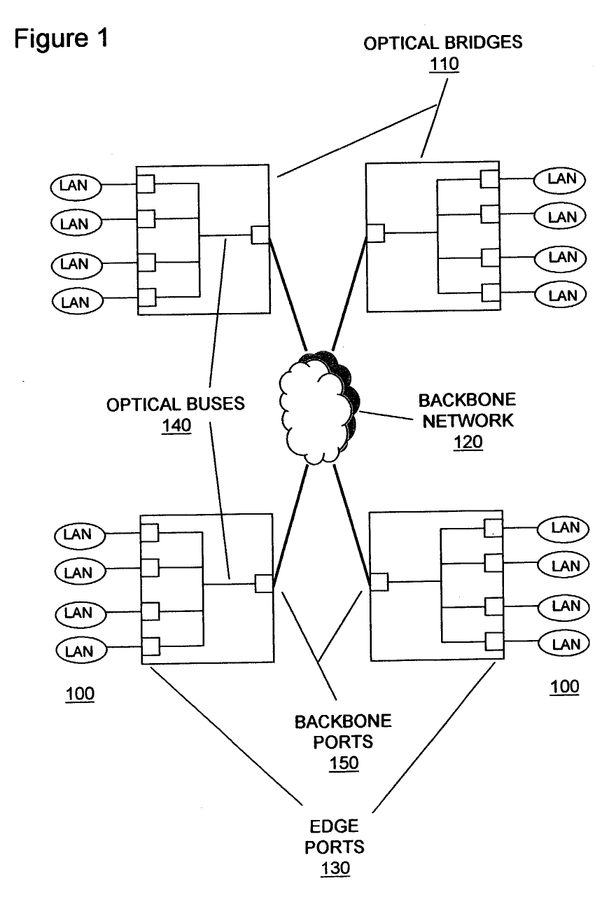

FIG. 1 shows a bridged local area network infrastructure in accordance with the present invention. LANs 100, which may be, for example, IEEE 802.3 wired Ethernet LANs or IEEE 802.11 wireless LANs, are communicatively coupled to one another via a plurality of optical bridges 110 and a backbone network 120. Optical bridges 110 each include a multiple of edge ports 130, one of backbone ports 150 and one of optical buses 140 to interconnect the ports. Optical buses 140 are fiber optic transmission media which consist of fiber optic cabling and passive couplers. Optical buses 140 operate according to the Wave Division Multiple Access (WDMA) access method. That is, optical buses 140 utilize wavelength separation to support concurrent transmission on buses 140 of data from each edge port and backbone port within their respective ones of bridges 110, without inter-symbol interference. LANs 100 each include one or more end-nodes, such as PCs, workstations, servers and printers. Backbone network 120 is a network providing VLAN Interconnectivity between bridges 110 through the expedient of explicit VLAN tagging. Backbone network 120 may be, for example, a native LAN backbone or a LAN-WAN backbone supporting a VLAN tunneling protocol over the WAN portion of the backbone.

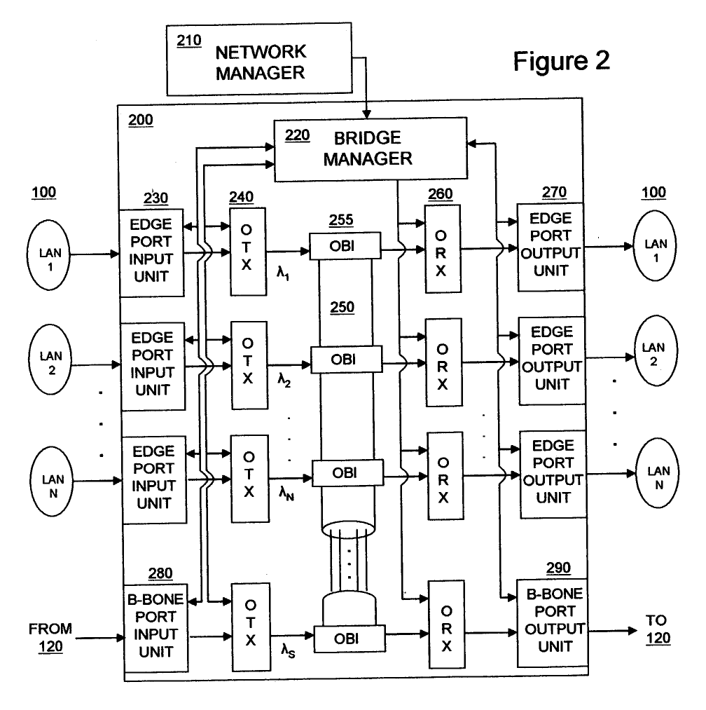

Turning to FIG. 2, an optical bridge 200, which is representative of optical bridges 110, is shown. Bridge 200 includes a bridge manager 220 which executes on bridge 200 policies defined by network manager 210 and downloaded to bridge manager 220 using network management commands. Bridge manager 220 executes the policies through updates of input units 230, 280, output units 270, 290, optical transmitters (OTXs) 240 and optical receivers (ORXs) 260, as appropriate, using bridge management commands. Updates are made in the background on control lines so as not to impede data transmission on bridge 200. Network manager 210 is not dedicated to bridge 200, but rather is a shared resource within the network connected to bridge manager 220 over a network management interface.

Input units 230, 280 include edge port Input units (EPIUs) 230 and backbone port input unit (BPIU) 280. EPIUs 230 have ports on respective ones of LANs 100 for receiving data packets from end-nodes. These ports are shared with their respective edge port output units (EPOUs) 270. EPIUs 230 have circuitry for performing checks and packet edits as needed and for passing data packets to their respective OTXs 240. BPIU 280 has a port on backbone network 120 for receiving data packets from backbone network 120. This port is shared with backbone port output unit (BPOU) 290. BPIU 280 has circuitry for performing checks and packet edits as needed and for passing data packets to its OTX. Input units 230, 280 each include packet processing circuitry, a shared (with their counterpart ones of output units 270, 290) content addressable memory (CAM) for MAC address “lookups” and random access memories (RAMs) for packet buffering and packet editing information storage. BPIU 280 includes additional circuitry for making VLAN level transmit wavelength selections for packets inbound from backbone network 120.

Output units 270, 290 include EPOUs 270 and BPOU 290. EPOUs 270 have ports on respective ones of LANs 100 for transmitting data packets to end-nodes. EPOUs 270 have circuitry for performing checks and packet edits as needed on data packets received from their respective ones of ORXs 260. BPOU 280 has a port on backbone network 120 for transmitting data packets to backbone network 120. BPOU 280 has circuitry for performing checks and packet edits as needed on data packets received from its ORX. Output units 270, 290 each include a packet processing circuit, a shared (with their counterpart ones of input units 230, 280) CAM for MAC address “lookups” and RAMs for packet buffering and packet editing information storage. BPOU 290 includes additional circuitry for VLAN tagging of packets outbound to backbone network 120.

Optical bridge 200 is a source learning bridge. Input units 230, 280 check the destination MAC address in each inbound packet against a “known address” table on the input unit. If the destination MAC address is found in the table, the packet is destined for an end-node presumed reachable through the port from which the packet was received and is filtered by the input unit. Additionally, input units 230, 280 check the source MAC address in each inbound packet against the “known address” table on the input unit to determine if such source MAC address is already known to be associated with the input unit If the source MAC address is not found in the table, the input unit apprises bridge manager 220 that an unknown MAC address has been seen on the input unit and the address is “learned.” That is, bridge manager 220 adds the MAC address to the “known address” table on the input unit and to a forwarding table on the corresponding output unit. The “known address” table and the forwarding table may be implemented as a single table shared by the input unit and output unit, in which case only one table update is made. In the case of BPIU 280, the VLAN of inbound packets is also identified from a VLAN tag in the inbound packet.

Packets not filtered at input units 230, 280 are broadcast on optical bus 250 to all output units 270, 290, except the one associated with the packet's input port.

Output units 270, 290 individually check the destination MAC address in each outbound packet against the forwarding table to determine whether to forward the outbound packet. If such destination MAC address is found in the forwarding table, an end-node to which the packet is destined is presumed reachable through the output unit's associated port and the packet is edited and forwarded. If not, the end-node to which the packet is destined is not presumed reachable through the output unit's associated port and the packet is filtered by the output unit, provided it is “claimed” for forwarding by another output unit on bridge 200. Output units 270, 290 assert a claim line (not shown) to indicate to other output units their “claiming” of a packet, that is, their intention to forward the packet. In the case of BPOU 290, outbound packets are VLAN-tagged prior to forwarding.

The operation of bridge 200 between input units 230, 280 and output units 270, 290, including wavelength-oriented virtual network operation, will now be described in more detail. Inbound packets which are not filtered by input units 230, 280 are passed to their respective OTXs 240. OTXs 240 perform electro-optical conversions and transmit packets to optical bus 250 on transmit wavelengths assigned to their associated ports, which transmit wavelength assignments are unique within bridge 200. Thus, the packets inbound on EPIUs 230 from LANs 1, 2, . . . N, which are not filtered, are converted to pulses and transmitted by their respective OTXs 240 to optical bus 250 via respective their respective optical bus interfaces (OBIs) 255 on transmit wavelengths λ₁, λ₂, . . . λ_{N} uniquely assigned to their respective edge ports. Packets inbound on BPIU 280 from other bridges are similarly converted and passed to optical bus 250 on a selected transmit wavelength λₛ associated with the VLAN on which the packet was received by BPIU 280 as indicated by the VLAN tag in the inbound packet.

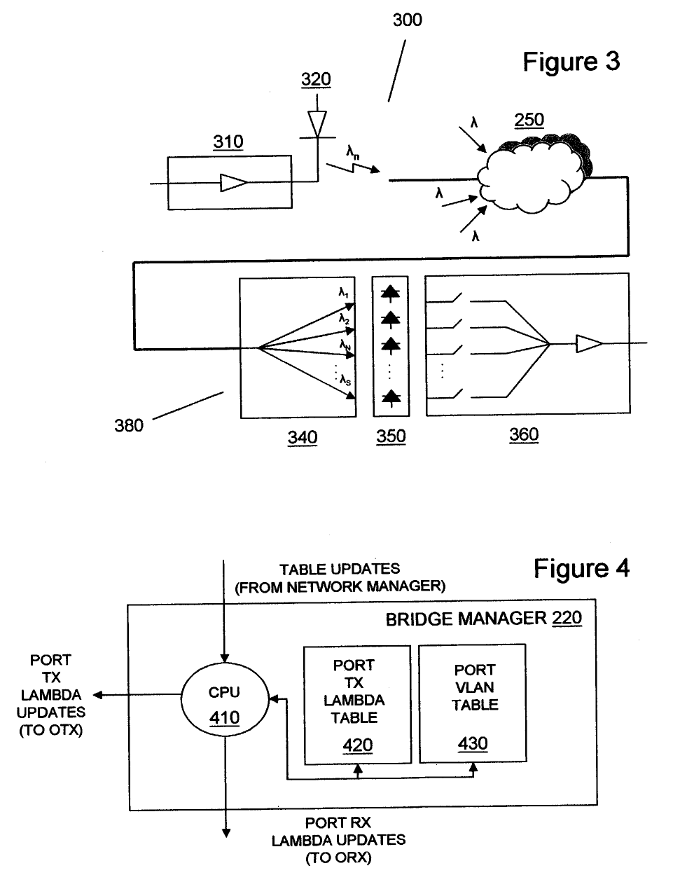

Turning to FIG. 3, OTX 300, which is representative of OTXs 240 associated with edge ports, is shown. OTX 300 includes laser driver circuit 310 and a laser diode 320 arranged to emit pulses on optical bus 250 at a fixed transmit wavelength λₙ assigned to the edge port with which OTX 300 is associated. The pulses emitted by laser diode 320 are wave division multiplexed on optical bus 250 with pulses emitted on other transmit wavelengths by other ones of OTXs 240. The OTX associated with BPIU 280 includes an array of fixed wavelength laser diodes associated with different transmit wavelengths, and selection circuit to select a particular diode/wavelength assigned to the VLAN on which the packet being transmitted on optical bus 250 was received.

Returning to FIG. 2, optical bus 250 interconnects OTXs 240 with ORXs 260 on a bidirectional optical path. Pulses received on the input of one of OBIs 255 from its associated input unit are broadcast bidirectionally down optical bus 250, if the OBI is not a bus endpoint. If the OBI is a bus endpoint, the pulse is transmitted unidirectionally. Pulses received by an OBI on optical bus 250 are “tapped off” to the output of the receiving 081 and also transmitted unidirectionally further down optical bus 250, if the OBI is not a bus endpoint. Each OBI has a coupler for broadcasting pulses received on its input onto optical bus 250, and a sampler for “tapping off” of optical bus 250 to the sampling OBI's output pulses received from other OBIs. Of course, rather than a bidirectional optical path, bus 250 may alternatively comprise two unidirectional optical paths.

Pulses tapped off OBI outputs are passed to their respective ones of ORXs 260. ORXs 260 spatially separate the disparate wavelength pulses received from optical bus 250 Into their component wavelengths, recover data received on wavelengths which correspond to receive wavelengths assigned to their respective ports, perform optical-electrical conversions on the recovered data and pass the recovered data to their respective output units 270, 290.

Returning to FIG. 3, ORX 380, which is representative of ORXs 260, is shown. ORX 380 includes optical demultiplexer 340 arranged to split the disparate wavelength pulses with respect to space. Optical demultiplexer 340 may be implemented using a diffraction grating, for example. ORX 380 further includes photodetector array 350 coupled to optical demultiplexer 340 for detecting the wavelength separated pulses. Photodetector array 350 may be a strip of semiconductive material containing an array of photosensitive structures such as metal-semiconductor-metal (MSM) photodetectors or PIN diodes, for example. ORX 380 further includes a selectable receiver circuit 360 connected to photodector array 350. Receiver circuit 360 has selector switches and amplifiers for recovering from photodetectors data received at the receive wavelengths assigned to receiver circuit's associated one of ports, amplifying the recovered data and passing the data in electronic form to receiver circuit's associated one of output units 270, 290. To avoid contention in passing the data to its one of output units 270, 290, receiver circuit 260 may temporarily store the recovered data in FIFOs which obtain access to the one of output units 270, 290 through arbitration.

At this point, it should be appreciated that through judicious assignment of receive wavelengths to ports in relation to their VLAN membership and configuration of ORXs 260 to effectuate such assignments, wavelength-selective recovery of data by ORXs 260 may be readily applied on bridge 200 to prevent communication across VLAN boundaries.

Turning now to FIG. 4, bridge manager 220 is shown in more detail. Bridge manager 220 includes central processing unit (CPU) 410 running bridge management software, port/transmit wavelength table 420 and port/VLAN table 430. CPU 410 receives network management commands from network manager 210 specifying network policies for execution, maintains tables 420, 430 and transmits bridge management commands to input units 230, 280, OTXs 240, ORXs 260 and output units 270, 290 to execute policies. CPU 410 enters into tables 420, 430 port/transmit wavelength associations and port/VLAN associations, respectively, for ports on bridge 200 in response to the most recent assignments specified in network management commands. CPU 410 effectuates transmit wavelength and receive wavelengths assignments through transmission to OTXs 240 and ORXs 260, respectively, of bridge management commands.

A transmit wavelength unique within bridge 200 is configured on the OTX associated with each edge port. In response to a bridge management command which includes an assigned transmit wavelength, the laser driver circuit on the OTX arranges the laser diode to emit pulses at the assigned transmit wavelength.

One or more transmit wavelengths unique within bridge 200 are configured on the OTX associated with the backbone port. In response to one or more bridge management commands which include one or more assigned transmit wavelengths and identification of the VLANs to which the respective transmit wavelengths apply, the laser driver circuit on the OTX arranges the laser diode array to emit pulses at the assigned transmit wavelengths, and arranges the selection circuit to select the appropriate laser diode for each transmitted packet based on the VLAN association of the packet.

CPU 410 determines receive wavelengths for application on ORXs 260 based on the current port/transmit wavelength associations and port/VLAN associations in tables 420, 430. For each edge port, CPU 410 assigns a group of one or more receive wavelengths which includes port level receive wavelengths and VLAN level receive wavelengths. Port level receive wavelengths include the group of transmit wavelengths assigned to other edge ports on bridge 200 which share a VLAN with the edge port. VLAN level receive wavelengths include the group of transmit wavelengths assigned to the backbone port on bridge 200 which correspond to VLANs to with the edge port belongs. For the backbone port, CPU 410 assigns port level receive wavelengths consisting in the group of transmit wavelengths assigned to edge ports on bridge 200 which share a VLAN with the backbone port. CPU 410 transmits bridge management commands including the assigned receive wavelengths to the appropriate ORXs 260. In response to the bridge management commands, the receiver circuits on ORXs 260 switch “on” selector switches coupled to photodetectors at assigned receive wavelengths and switch “off” selector switches coupled to photodetectors at other than the assigned receive wavelengths.

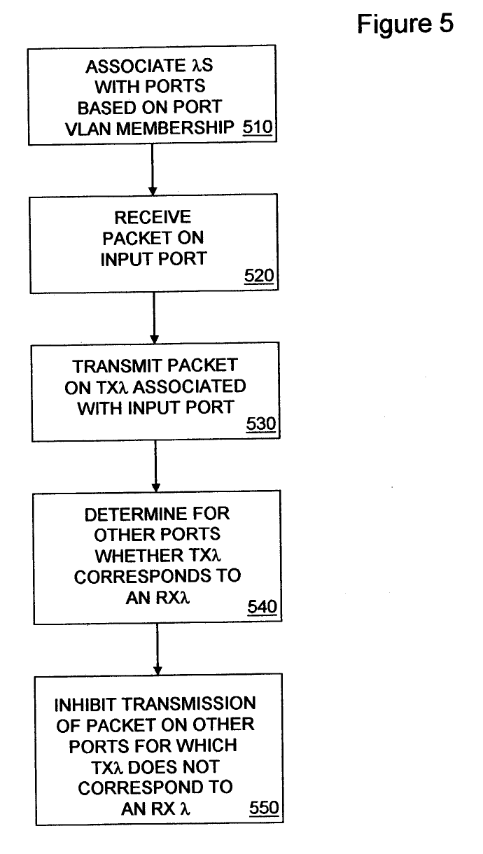

Turning finally to FIG. 5, a flow diagram illustrates a wavelength-oriented virtual network protocol for the bridged local area network in accordance with the present invention. Wavelengths are associated with ports of a bridge based on the VLAN membership of ports (510). Preferably, receive wavelengths are assigned to ports to recover data received on transmit wavelengths (and by implication received from ports or on VLANs) with which such receiving ports have VLAN correspondence, and to inhibit recovery of data received on other transmit wavelenghts. A packet is received on an input port (520). The packet is transmitted to other ports of the bridge on a transmit wavelength associated with the input port (530). Preferably, the transmit wavelength can be either a port level transmit wavelength in the case of an edge input port or a VLAN level transmit wavelength in the case of a backbone input port. The other ports individually determine whether the transmit wavelength corresponds to a receive wavelength associated therewith (540). Transmission of the packet is inhibited from the other ports for which the transmit wavelength does not correspond to a receive wavelength (550). A wavelength-oriented virtual network construct is thereby effectuated.

It will be appreciated by those of ordinary skill in the art that the invention can be embodied in other specific forms without departing from the spirit or essential character hereof. As one example, as an alternative to assigning VLAN-conforming receive wavelengths based on preassigned transmit wavelengths, VLAN-conforming transmit wavelengths may be assigned based on preassigned receive wavelengths. The present invention is therefore considered in all respects to be illustrative and not restrictive. The scope of the invention is indicated by the appended claims, and all changes that come with in the meaning and range of equivalents thereof are intended to be embraced therein.

I claim:

1. A data communication switching domain, comprising:
a plurality of ports coupled to respective ones of transmitting/receiving nodes, each of the plurality of ports being communicatively coupled to each of the other of the plurality of ports;
each of the plurality of ports having associated therewith one or more transmit wavelengths for transmitting data to other of the plurality of ports; and
each of the plurality of ports having associated therewith one or more receive wavelengths for selectively passing, based on the transmit wavelengths, data received from other of the plurality of ports,
wherein receive wavelengths are selectively associated with ports based on virtual network membership.

2. The data communication switching domain of claim 1, wherein the plurality of ports are communicatively coupled by a WDMA optical transmission medium.

3. The data communication switching domain of claim 1, wherein each transmit wavelength is associated with only one of the plurality of ports.

4. The data communication switching domain of claim 1, wherein the virtual network is a VLAN.

5. The data communication switching domain of claim 1, wherein the communicative couplings between the plurality of ports and the respective transmitting/receiving nodes are LAN couplings.

6. The data communication switching domain of claim 1, wherein each of the plurality of ports has associated therewith an optical receiver coupled to receive data from other of the plurality of ports on the transmit wavelengths, pass data corresponding to any of the receive wavelengths associated with such receiving port, and block data not corresponding to any of the receive wavelengths associated with such receiving port.

7. A data communication switching domain for communicating data between transmitting/receiving nodes, comprising:
a plurality of ports coupled to respective ones of the transmitting/receiving nodes, each of the plurality of ports being communicatively coupled to each of the other of the plurality of ports;
each of the plurality of ports having associated therewith one or more transmit wavelengths for transmitting data to other of the plurality of ports; and
each of the plurality of ports having associated therewith one or more receive wavelengths for selectively passing, based on the transmit wavelengths, data received from other of the plurality of ports,
wherein ports are selectively assigned, based on virtual network membership, receive wavelengths corresponding to transmit wavelengths of other ports.

8. The data communication switching domain of claim 7, wherein the plurality of ports are communicatively coupled by a WDMA optical transmission medium.

9. The data communication switching domain of claim 7, wherein each transmit wavelength is associated with only one of the plurality of ports.

10. The data communication node of claim 7, wherein the virtual network is a VLAN.

11. The data communication node of claim 7, wherein the communicative couplings between the plurality of ports and the respective transmitting/receiving nodes are LAN couplings.

12. The data communication node of claim 7, wherein each of the plurality of ports has associated therewith an optical receiver coupled to receive data from other of the plurality of ports on the transmit wavelengths, pass data corresponding to any of the receive wavelengths assigned to such receiving port, and block data not corresponding to any of the receive wavelengths assigned to such receiving port.

13. A data communication switching domain for communicating data between transmitting/receiving nodes, comprising:
a plurality of ports coupled to respective ones of the transmitting/receiving nodes, each of the plurality of ports being communicatively coupled to each of the other of the plurality of ports;
each of the plurality of ports having associated therewith one or more transmit wavelengths for transmitting data to other of the plurality of ports; and
each of the plurality of ports having associated therewith one or more receive wavelengths for selectively passing, based on the transmit wavelengths, data received from other of the plurality of ports,
wherein ports are selectively assigned, based on virtual network membership, receive wavelengths corresponding to transmit wavelengths of virtual networks.

14. The data communication switching domain of claim 13, wherein the plurality of ports are communicatively coupled by a WDMA optical transmission medium.

15. The data communication switching domain of claim 13, wherein each transmit wavelength is associated with only one of the plurality of ports.

16. The data communication node of claim 13, wherein the virtual networks are VLANs.

17. The data communication node of claim 13, wherein the communicative couplings between the plurality of ports and the respective transmitting/receiving nodes are LAN couplings.

18. The data communication node of claim 13, wherein each of the plurality of ports has associated therewith an optical receiver coupled to receive data from other of the plurality of ports on the transmit wavelengths, pass data corresponding to any of the receive wavelengths assigned to such receiving port, and block data not corresponding to any of the receive wavelengths assigned to such receiving port.

19. A data communication switching domain for communicating data between transmitting/receiving nodes, the network comprising:
a plurality of edge ports coupled to respective ones of the transmitting/receiving nodes; and
a backbone port coupled to a backbone network,
wherein each of the plurality of edge ports and the backbone port are communicatively coupled to one another, each of the plurality of edge ports and the backbone port has associated therewith one or more transmit wavelengths for transmitting data to one another, each of the plurality of edge ports and the backbone port has associated therewith one or more receive wavelengths for selectively passing, based on the transmit wavelengths, data received from one another, and
wherein receive wavelengths are selectively associated with the edge ports and the backbone port based on virtual network membership.

20. The data communication node of claim 19, wherein the plurality of edge ports and the backbone port are communicatively coupled to one another by a WDMA optical transmission medium.

21. The data communication node of claim 19, wherein the virtual network is a VLAN.

22. The data communication node of claim 19, wherein each of the plurality of edge ports has associated therewith an optical receiver coupled to receive data from other of the plurality of ports on the transmit wavelengths, pass data corresponding to any of the receive wavelengths associated with such receiving edge port, and block data not corresponding to any of the receive wavelengths associated with such receiving edge port.

23. In a data communication network that includes at least one data communication domain for communicating data among transmitting/receiving nodes, the data communication domain having a number of ports coupled to corresponding ones of transmitting/receiving nodes to receive data from, and transmit data to, such nodes, a method of transmitting data received at one of the number of ports from selected other ones of the number of ports, comprising the steps of:
selectively associating with each of the number of ports, based on virtual network membership, one or more wavelengths;
receiving data on one of the number of ports;
transmitting the data from the one of the number of ports on a transmit wavelength associated with the one of the number of ports;
determining for each of the other ones of the number of ports whether the transmit wavelength corresponds with a receive wavelength associated with such other one of the number of ports; and
inhibiting transmission of the data on such other ones of the number of ports for which the transmit wavelength does not correspond with any receive wavelength associated therewith.

24. The method of claim 23, wherein the wavelengths associated in the associating step are receive wavelengths.

25. The method of claim 23, wherein the wavelengths associated in the associating step are port level wavelengths.

26. The method of claim 23, wherein the wavelengths associated in the associating step are VLAN level wavelengths.

27. The method of claim 23, wherein the virtual network is a VLAN.
